(19) United States
(12) Patent Application Publication
(10) Pub. No.: US 2018/0270343 A1
(43) Pub. Date: Sep. 20, 2018

(54) ENABLING EVENT-DRIVEN VOICE TRIGGER PHRASE ON AN ELECTRONIC DEVICE

(71) Applicant: Motorola Mobility LLC, Chicago, IL (US)

(72) Inventors: Satyabrata Rout, Bangalore (IN); Amit Kumar Agrawal, Bangalore (IN); Himanshu Chug, Bangalore (IN)

(21) Appl. No.: 15/806,064

(22) Filed: Nov. 7, 2017

(30) Foreign Application Priority Data
Mar. 20, 2017 (IN) 201731009667

(51) Int. Cl. H04M 1/725; G10L 15/22; G06F 3/16

(52) U.S. Cl. CPC H04M 1/72569; H04M 1/7255; H04M 1/72577; G10L 15/22; G06F 3/167; H04M 1/72597

(57) ABSTRACT

A processor identifies a no touch no see (NTNS) context. A notification of a non-user initiated event is received, with the event not being associated with a user interaction with the device, and at least responsive to identifying the NTNS context, a NTNS trigger is enabled. Receipt of a voice signal matching the NTNS trigger is awaited at the user's convenience. Responsive to receiving the voice signal matching the NTNS trigger, the notification is read out and touchless voice interaction is initiated.

### FIELD

The present application relates to technically inventive, non-routine solutions that are necessarily rooted in computer technology and that produce concrete technical improvements.

### BACKGROUND

Many mobile devices allow user interaction through natural language voice commands. Typically, a user presses a button or speaks a trigger phrase to enable the voice communication. Often, the user desires to employ voice commands to operate in a hands-free mode, such as while driving. As understood herein, requiring the user to initiate the voice command mode using a button does not provide a true hands-free environment.

### SUMMARY

As further understood herein, while opening a voice recognition path in response to the device receiving a notification addresses in part the above shortcomings, a difficulty arises when the notification arrives when the user is not in an appropriate situation for voice interaction, such as while driving in heavy traffic, or with another person in the vehicle also talking, etc. Thus, present principles identify a need to enable a user to choose when exactly to initiate a touchless voice interaction.

Accordingly, a method includes identifying an event generated by an application executed by a processor in a device. The event is not associated with a user interaction with the device. The method includes, without requesting or receiving user input from a user of the device, unloading a first voice operation trigger phrase and loading a second voice operation trigger phrase to identify a user voice command, and executing the user voice command.

In example embodiments, the method may include generating an event alert notification responsive to identifying the event. The event may be associated with an incoming message or an incoming call or an event associated with an application executing on the device.

In some examples, the event is generated by an application. In non-limiting embodiments the second voice operation trigger phrase is unloaded, and the first voice operation trigger phrase is loaded responsive to the notification being consumed by the device.

In another aspect a storage that is not a transitory signal includes instructions executable by a processor to identify a no touch no see (NTNS) context. The instructions are executable to receive a notification of a non-user initiated event that is not associated with a user interaction with the device, and at least responsive to identifying the NTNS context, to enable a NTNS trigger. The instructions are further executable to wait for receipt of a voice signal matching the NTNS trigger, and responsive to receiving the voice signal matching the NTNS trigger, read out the notification and initiate a touchless voice interaction.

In another aspect, an apparatus includes a first processor, a network adapter, and storage with instructions executable by the first processor for enabling a no touch can see (NTCS) mode. The instructions are executable for receiving input indicating a context change, and responsive to the input, enabling a no touch no see (NTNS) mode. The instructions are executable for, in the NTNS mode, receiving a notification is received of an incoming communication, indicating the notification without reading it out, and waiting until a NTNS voice trigger is received. The instructions are executable for, responsive to receiving the NTNS voice trigger, reading out the notification and initiating a touchless voice interaction.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of an example network of devices in accordance with present principles;

FIG. 3 is a flow chart of example logic consistent with present principles;

FIG. 4 is an example user interface (UI) consistent with the logic of FIG. 3;

FIG. 5 is a flow chart of example notification logic consistent with present principles; and

FIGS. 6 and 7 are example UIs consistent with the logic of FIG. 5.

### DETAILED DESCRIPTION

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp, of Redmond, Wash. A Unix® or similar such as Linux® operating system may be used. These operating systems can execute one or more browsers such as a browser made by Microsoft or Google or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any conventional general-purpose single- or multi-chip processor that can execute logic by means of various lines such as address lines, data lines, and control lines and registers and shift registers. Moreover, any logical blocks, modules, and circuits described herein can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor then being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

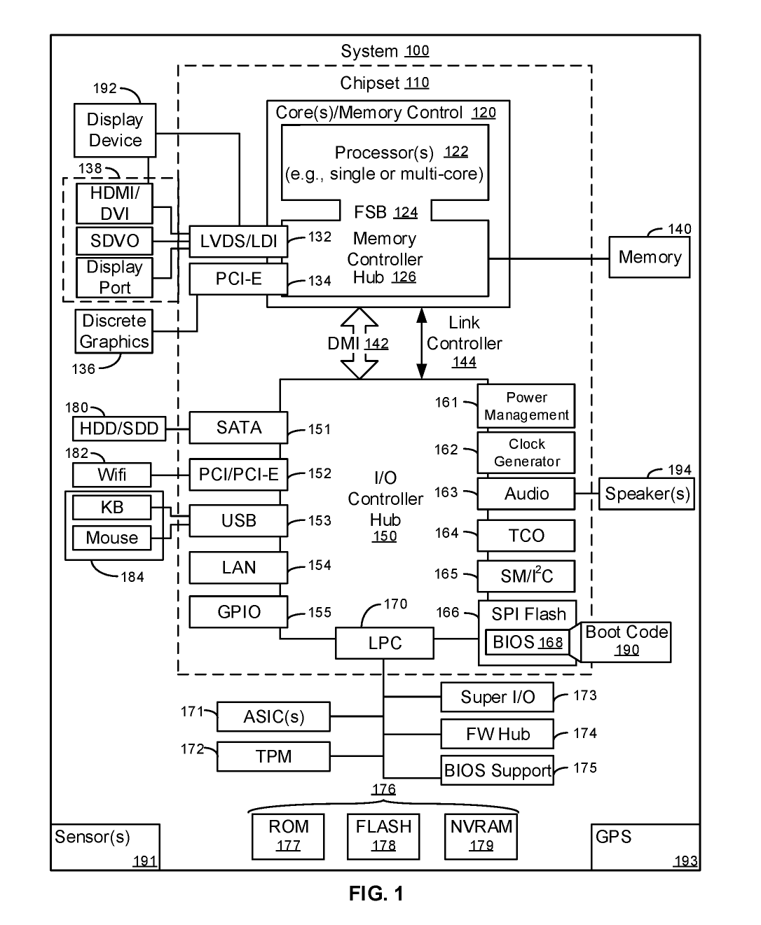

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, DSPs, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc. In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the 110 hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose 110 interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case, the drives 180 are understood to be, e.g., tangible computer readable storage mediums that are not transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

The system 100 may also include one or more sensors 191 from which input may be received for the system 100. For example, the sensor 191 may be an audio receiver/microphone that provides input from the microphone to the processor 122 based on audio that is detected, such as via a user providing audible input to the microphone, so that the user may be identified based on voice identification. As another example, the sensor 191 may be a camera that gathers one or more images and provides input related thereto to the processor 122 so that the user may be identified based on facial recognition or other biometric recognition. The camera may be a thermal imaging camera, a digital camera such as a webcam, a three-dimensional (3D) camera, and/or a camera otherwise integrated into the system 100 and controllable by the processor 122 to gather pictures/images and/or video. The sensor 191 may also be, for instance, another kind of biometric sensor for use for such purposes, such as a fingerprint reader, a pulse monitor, a heat sensor, etc.

The sensor 191 may even be a motion sensor such as a gyroscope that senses and/or measures the orientation of the system 100 and provides input related thereto to the processor 122, and/or an accelerometer that senses acceleration and/or movement of the system 100 and provides input related thereto to the processor 122. Thus, unique and/or particular motion or motion patterns may be identified to identify a user as being associated with the motions/patterns in accordance with present principles.

Additionally, the system 100 may include a location sensor such as but not limited to a global positioning satellite (GPS) transceiver 193 that is configured to receive geographic position information from at least one satellite and provide the information to the processor 122. However, it is to be understood that another suitable position receiver other than a GPS receiver may be used in accordance with present principles to determine the location of the system 100. In some embodiments, the GPS transceiver 193 may even establish a sensor for use in accordance with present principles to identify a particular user based on the user being associated with a particular location (e.g., a particular building, a particular location within a room of a personal residence, etc.)

It is to be understood that an example client device or other machine/computer may include fewer or more features than shown on the system 100 of FIG. 1. In any case, it is to be understood at least based on the foregoing that the system 100 is configured to undertake present principles.

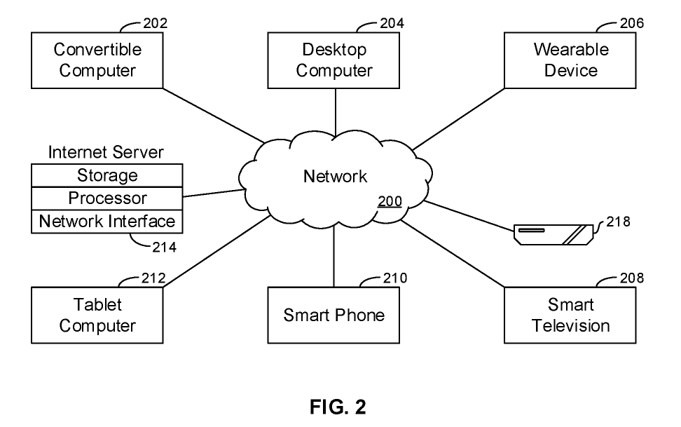

Turning now to FIG. 2, example devices are shown communicating over a network 200 such as the Internet in accordance with present principles. It is to be understood that each of the devices described in reference to FIG. 2 may include appropriate features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, a server 214 such as an Internet server that may provide cloud storage accessible to the devices shown in FIG. 2, and a game console 218. It is to be understood that the devices shown in FIG. 2 are configured to communicate with each other over the network 200 to undertake present principles.

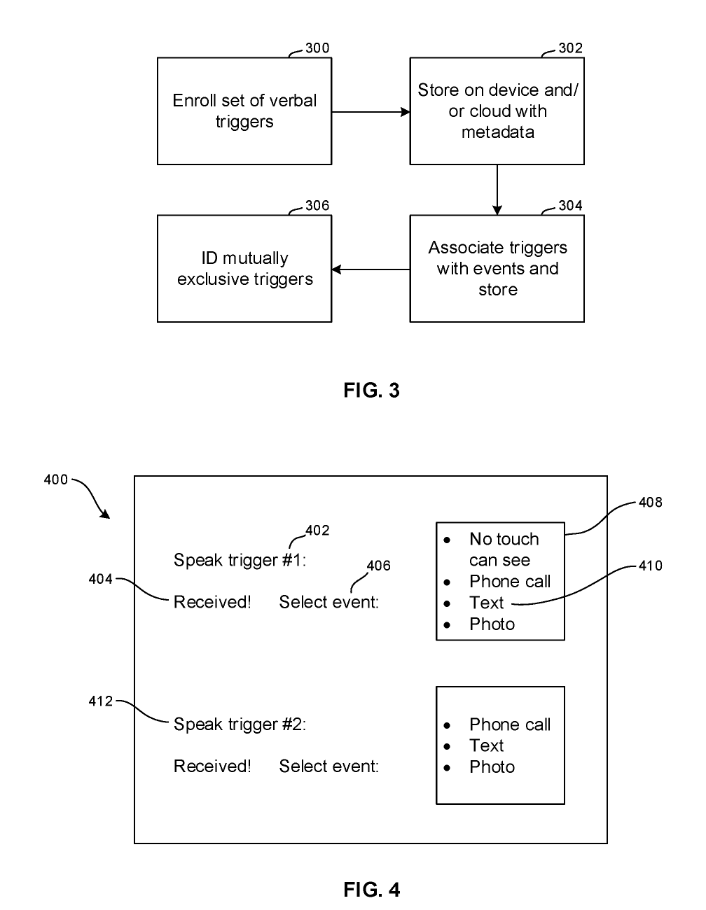

FIGS. 3 and 4 illustrate initialization aspects consistent with present principles. Commencing at block 300 of FIG. 3, a set of one or more verbal triggers is established. This set of triggers may be established at the factory or an end user of a device such as the smart phone 210 may be accorded the opportunity to establish the trigger set himself. The triggers are stored at block 302 on the device and/or in the cloud. Note that raw audio data for each trigger may be saved along with corresponding supplemental metadata such as sampling rate, device configuration, etc.

Moving to block 304, the triggers are associated with respective events and the associations stored. Any mutually exclusive triggers, i.e., triggers that initiate or require mutually exclusive actions, can be identified at block 306 and stored as such.

FIG. 4 illustrates. In one embodiment the logic of FIG. 3 may be done by factory pre-loading of the trigger set into a device such as the smart phone 210 in FIG. 2 or by presenting a user interface (UI) 400 visibly and/or audibly on a device such as the smart phone 210 in FIG. 2 to allow an end user to tailor the trigger set. When done in a factory the UI 400 may be used by a technician to establish and pre-load the triggers.

In the example shown, the UI 400 includes a first prompt 402 to speak or otherwise input (as by a key entry device) a first verbal trigger. For disclosure purposes assume the first verbal trigger is “show me”. A message 404 may be presented to assure the user that the trigger has been received, and then a prompt 406 presented to prompt the user to select one or more events that are to be associated with the first trigger. Selection may be made, e.g., from a list 408 of events 410.

In the example shown, one event may be “no touch can see” (NTCS), in this case alluding to an event associated with a user interaction with the device such as speaking the first trigger (the example “show me”) followed by a command, such as “my calendar”. Thus, the phrase “show me” followed by “my calendar” would cause the device to present an electronic calendar from the cloud or local storage on a video display of the device and if desired to present the calendar audibly.

Other events 410 on the list 408 may include non-user initiated events that are not associated with a user interaction with the device, such as an incoming phone call, an incoming text message, an incoming photo message, an incoming video call, an incoming email, and the like. In some embodiments, the event may be associated with an application executing on the device, such as a music player, video player, etc. In general, a non-user initiated event is some action or activity not initiated by the user at the time the event occurs but that is identified by the device.

Once the first trigger is established, a prompt 412 may be presented to establish a second trigger. Additional triggers may be established in this manner.

In an example, the second trigger is a “no touch no see” (NTNS) trigger, an example specimen of which may be “what was that?” Details of a NTNS trigger are discussed further below.

A NTCS trigger (such as the example “show me”) is applicable when user can look at the device. However, a NTNS trigger such as the example “what was that” is more applicable when the user doesn't have the convenience of looking or touching the device such as when he is driving/cooking/walking using a wired or wireless headset communicatively coupled to the device. Generally, a NTCS trigger (which assumes the user conveniently may look at a display) is mutually exclusive to a NTNS trigger, which assumes the opposite.

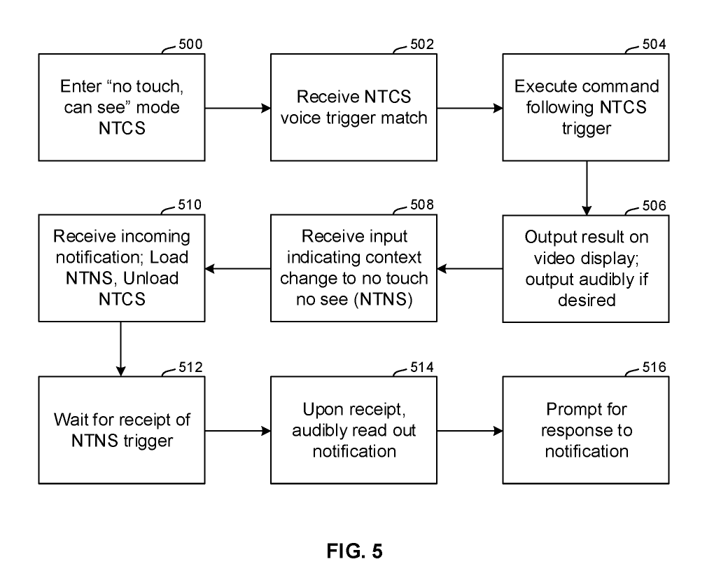

Referring now to FIG. 5, assume that at block 500 the device is in a NTCS mode, either responsive to user input or to one or more of the context determinations discussed below. At block 502 a voice input is received matching the NTCS voice trigger, typically followed by a command. The command following the NTCS trigger typically is executed at block 504 with an output of the execution being output on a video display at block 506 and if desired or alternatively output audibly on a speaker of the device.

One example of a NTCS command was introduced above. Additional non-limiting examples include but are not limited to “schedule”, in which case an electronic schedule is presented, “next meeting”, in which case details such as time and location of a next meeting on an electronic calendar or schedule are presented, “weather”, in which case weather information is presented, “notifications”, in which case notifications (of for example, missed calls) are presented, “open applications”, in which names of open applications are presented, “application functions”, in which case functions of applications are presented, “open [application name]”, in which the application whose generic name follows the word “open” is invoked, etc.

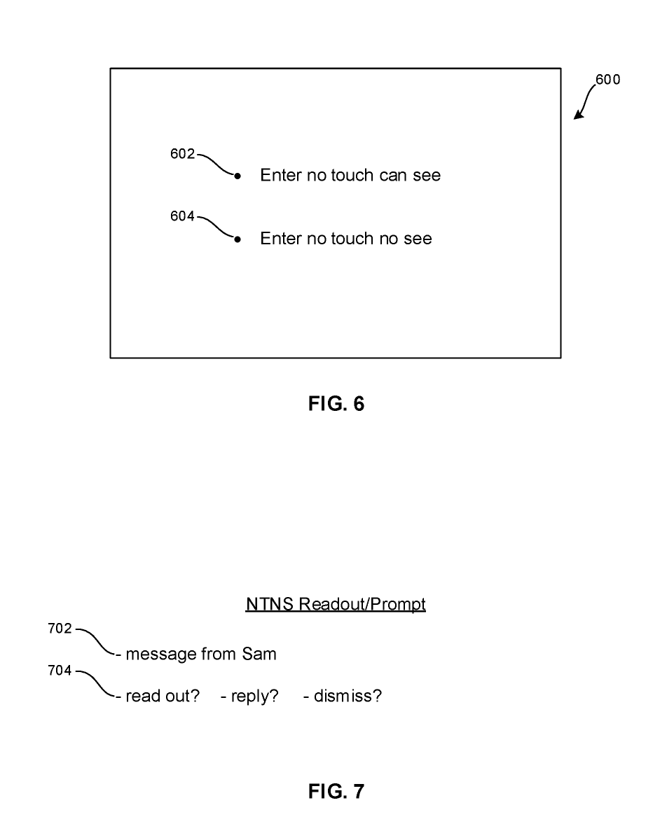

Block 508 indicates that an input may be received by the device indicating a context change, and specifically a context change from a NTCS situation to a NTNS situation. Referring briefly to FIG. 6, this may be accomplished by presenting a UI 600 on the device with a selector 602 selectable to indicate the NTCS mode and a second selector 604 selectable to indicate the NTNS mode. In other words, the user may indicate the mode.

There are many other ways consistent with present principles for the device to know it is transitioning from a NTCS mode to a NTNS mode. For example, if a Bluetooth link to a headset is initiated, the NTNS mode may be indicated automatically. Or, if a motion sensor such as any of those described above in reference to FIG. 1 indicate motion above a threshold. NTNS may be indicated. Yet again, if a location signal from a location sensor such as that described above in reference to FIG. 1 indicates a particular location, the particular location may be correlated in a data structure accessible to the device to be associated with NTNS, e.g., a symphony hall. Camera images and microphone input may similar indicate situations correlated to NTNS.

Moving to block 510, a notification is received of an incoming message such as a phone call, video message, text message, email, and so on. In response, NTNS is enabled and if desired NTCS is disabled. Loading NTNS trigger operation while unloading NTCS trigger operation is particularly relevant in which a DSP executes the logic, recognizing that devices with single DSP have limitations of working with a very limited set of trigger phrases primarily due to memory constraints. Here, “load” means load into memory (such as DSP memory) the new template trigger phrase to compare against input from the microphone, whereas “unload” means remove the old template trigger phrase to compare against input from memory.

The logic thereafter waits to read out or otherwise display the content of the notification. The existence of a pending notification may be indicated by, e.g., a sonic beep or a tactile signal or other means, but block 512 indicates that presentation of the notification is held in abeyance based on the user's convenience. At such time as the user is in a convenient situation to hear a readout of the notification, he speaks the NTNS trigger which is received at block 514 via, e.g., the low power microphones attached to the DSP of the device, causing the device to audibly read out the notification. A microphone of the device may also be opened (enabled) at block 514. A prompt to respond may be returned by the device at block 516. Note that even though in the NTNS mode, a visual readout and prompt may also be provided.

Note further that after the readout at block 514, if the user missed the readout he could repeat the NTNS trigger (e.g., “what was that”) to cause the readout to be repeated.

Again, with a view to conserving DSP memory resources, the NTNS trigger can be unloaded if desired responsive to the user choosing to dismiss the notification and loaded back once again when another notification arrives, or responsive to the notification being read out, or responsive to the device otherwise exiting the NTNS mode according to any of the example mechanisms described herein.

FIG. 7 illustrates example outputs at blocks 514 and 516 of FIG. 5. FIG. 7 represents a UI 700 that is preferably presented audibly on one or more speakers of the device. It may also be presented on a video display of the device.

A notification 702 is read out. In the example shown, the notification indicates an incoming message from a number that has been correlated using a contact list to a contact named “Sam”. The telephone number itself may be read out.

A prompt 704 may be presented, presenting one or more response options. In the example shown, the user is prompted to readout the message, send a reply or dismiss the message. The user would then speak the desired prompt to execute the underlying action, i.e., to answer the call, allow it to ring through without voice mail, and allowing it to ring through to voice mail. It will readily be appreciated that this requires no gazing by the user at the device or touching of the device, and moreover, due to the wait at block 512, is done only at such time as the user finds it convenient to turn his attention to the notification.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory signal and/or a signal per se.

It is to be understood that whilst present principals have been described with reference to some example embodiments, these are not intended to be limiting, and that various alternative arrangements may be used to implement the subject matter claimed herein. Components included in one embodiment be used in other embodiments in any appropriate combination. For example, any of the various components described herein and/or depicted in the Figures may be combined, interchanged or excluded from other embodiments.

What is claimed is:

1. A method comprising:
identifying an event generated by an application executed by a processor in a device, wherein the event is not associated with a user interaction with the device;
without requesting or receiving user input from a user of the device, unloading a first voice operation trigger phrase and loading a second voice operation trigger phrase to identify a user voice command; and
executing the user voice command.

2. The method of claim 1, further comprising generating an event alert notification responsive to identifying the event.

3. The method of claim 1, wherein the event is associated with an incoming message.

4. The method of claim 1, wherein the event is associated with an incoming call.

5. The method of claim 1, wherein the event is generated by an application.

6. The method of claim 1, wherein the second voice operation trigger phrase is unloaded, and the first voice operation trigger phrase is loaded responsive to the notification being consumed by the device.

7. A device, comprising:
at least one processor; and
storage accessible to the at least one processor, the storage comprising instructions executable by the processor to:
identify a no touch no see (NTNS) context;
receive a notification of a non-user initiated event that is not associated with a user interaction with the device;
at least responsive to identifying the NTNS context, enable a NTNS trigger;
wait for receipt of a voice signal matching the NTNS trigger; and
responsive to receiving the voice signal matching the NTNS trigger, read out the notification.

8. The device of claim 7, wherein the instructions are executable to generate an alert of the notification responsive to receiving the notification but not reading out the notification prior to receipt of a voice signal matching the NTNS trigger.

9. The device of claim 7, wherein the event is associated with an incoming message.

10. The device of claim 7, wherein the event is associated with an incoming call.

11. The device of claim 7, wherein the event is generated by an application executing on the device.

12. The device of claim 7, wherein the instructions are executable to unload the NTNS trigger phrase responsive to the notification being dismissed by input to the device.

13. An apparatus, comprising:
at least a first processor;
at least one network adapter; and
storage with instructions executable by the first processor for:
enabling a no touch can see (NTCS) mode;
receiving input indicating a context change;
responsive to the input, enabling a no touch no see (NTNS) mode;
in the NTNS mode, receiving a notification is received of an incoming communication;
indicating the notification without reading it out;
waiting until a NTNS voice trigger is received; and
responsive to receiving the NTNS voice trigger, reading out the notification.

14. The apparatus of claim 13, wherein the instructions are executable for reading out the notification audibly.

15. The apparatus of claim 13, wherein the instructions are executable for reading out the notification visibly.

16. The apparatus of claim 13, wherein the instructions are executable for indicating the notification tactilely,

17. The apparatus of claim 13, wherein the instructions are executable for indicating the notification sonically.

18. The apparatus of claim 13, wherein the instructions are executable for outputting a prompt to respond to the notification.
